(19) United States
(12) Patent Application Publication
(10) Pub. No.: US 2014/0068538 A1
(43) Pub. Date: Mar. 6, 2014

(54) AUTOMATED NOISE CHARACTERIZATION AND COMPLETENESS AND CORRECTNESS OF NOISE DELIVERABLES

(71) Applicants: Shruthi Arun, Mysore (IN); Lun Ye, Bridgewater, NJ (US); Diwakar Ramadasu, Bangalore (IN)

(72) Inventors: Shruthi Arun, Mysore (IN); Lun Ye, Bridgewater, NJ (US); Diwakar Ramadasu, Bangalore (IN)

(73) Assignee: LSI Corporation

(21) Appl. No.: 13/602,757

(22) Filed: Sep. 4, 2012

(51) Int. Cl. G06F 17/50

(52) U.S. Cl. 716/115

(57) ABSTRACT

Methods, systems and processor-readable media for automatic self-tracking of input deliverables for noise characterization. A noise characterization run to generate a noise model thereof can be automatically initiated. The noise model can be delivered into a repository in response to completing the noise characterization run and generating the noise model. Data associated with the noise model can be tracked for subsequent analysis including checking completeness and a correctness of the noise model delivered into the repository, The data associated with the noise model can then be rendered for the subsequent analysis. Data associated with the noise model can include, for example, information regarding pending tasks, assignment information, and data contained in a noise database.

### TECHNICAL HELD

Embodiments are generally related to the field of noise characterization. Embodiments are additionally related to methods and systems for tracking and verifying noise characterization data.

### BACKGROUND OF THE INVENTION

The library development cycle is the busiest activity for circuit designers and modeling teams. Every other day, for example, new libraries are added into a technology node, hundreds of new cells checked into a library, and new process corners characterization occur due to ever growing customer requests. In 28 nm technology node, for example, one can find about 176 core cell libraries, 173 IO's and Complex IP cells. Each of the core cell libraries has about 66 PVT corners with over 1000 cells in each library. This constitutes a huge database to handle and there typically are not very good centralized mechanisms available to keep track of all the development activities. The volume of database information and data thereof becomes multiplied with different versions of the technology node and with multiple technology nodes.

One existing tracking system “phoenix” is a manually controlled system. The modeling team managers trigger the model requests through the phoenix system depending on the priority of the library. This system tracks only the newly added or checked libraries. The characterization process, however, occurs at multiple phases with incremental PVTs. A mechanism does not exist to efficiently track these incremental releases. The only approach to keeping track of the new update is through delivery notice mails. Due to the vastness of library data and numerous check-ins, this approach is very cumbersome and highly error prone to handle the database through mails. Since the input deliverables required for characterization are not available in systematic form, this approach severely limits the auto-characterization and model delivery flow.

To cater to the growing demand for increased number of libraries and PVT corner characterization, an efficient and robust tracking system is a must. A system which self triggers the characterization runs and re-triggers the failed simulations is the key to minimize human intervention and improve efficiency. Also, there is a need for a system, which keeps track of the quality of deliverables.

Disadvantages of existing approaches include the use of a huge database to keep track through e-mail notifications, along with a strong chance of missing new library and cell characterization, because such approaches are based on manual systems. Other disadvantages include systems in which characterization runs begin only after the notification mails are delivered even though upstream kits are available for characterization. This leads to a significant lag in the characterization process and overall model turnaround time. If the delivered models are erroneous, such errors may not be identified until reported by customers.

The existing notification e-mails also lack precise information regarding the latest updates and characterization needs. Other problems include the fact that such approaches are very difficult to employ in prioritizing libraries for characterization and estimation of the overall characterization workload. This leads to the inefficient usage of tools, machine resources, and man-hours. In such situations, the characterization runs are manually triggered and require continuous monitoring of failed jobs and simulations. In general, the current approach is very cumbersome and does not keep track of finished tasks and pending tasks as there are no centralized work assignment reports.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved noise characterization method, system and processor-readable medium.

It is another aspect of the disclosed embodiments to provide for a noise characterization method, system and processor-readable medium for storing, tracking, and verifying noise characterization data.

The aforementioned aspects and other objectives and advantages can now be achieved as described herein. Methods, systems and processor-readable media for automatic self-tracking of input deliverables for noise characterization are disclosed. In general, noise characterization run to generate a noise model thereof can be automatically initiated. The noise model can be delivered into a repository in response to completing the noise characterization run and generating the noise model. Data associated with the noise model can be tracked for subsequent analysis including checking completeness and a correctness of the noise model delivered into the repository. The data associated with the noise model can then be rendered for the subsequent analysis. Data associated with the noise model can include, for example, information regarding pending tasks, assignment information, and data contained in a noise database. Such data can be rendered via an internal noise characterization webpage. The noise characterization runs can be automatically initiated as required library set-ups are needed.

An automation can thus be configured, which enables self-tracking of input deliverables for noise characterization. Such an approach automatically triggers characterization runs and completes the noise modeling activity. This setup approach keeps track of pending tasks, so-called “phoenix” assignments and a complete noise database, and publishes such information on the internal noise characterization webpage. This approach is very robust and can check the completeness and correctness of noise models delivered into the repository (e.g., a noise delivery database, library database, etc.). With this end-to-end automation in place, a 100% fool proof noise model generation and deliverables thereof can be achieved.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a pictorial view of a noise assignment report, in accordance with the disclosed embodiments;

FIG. 2 illustrates a flow chart of operations depicting logical operational steps of an automated tracking and characterization flow, in accordance with the disclosed embodiments;

FIG. 3 illustrates a flow chart of operations depicting coverage analysis flow, in accordance the disclosed embodiments;

FIG. 4 illustrates a block diagram of a data-processing system that may be utilized to implement one or more embodiments; and

FIG. 5 illustrates a computer software system for directing the operation of the data-processing system depicted in FIG. 4, in accordance with an example embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

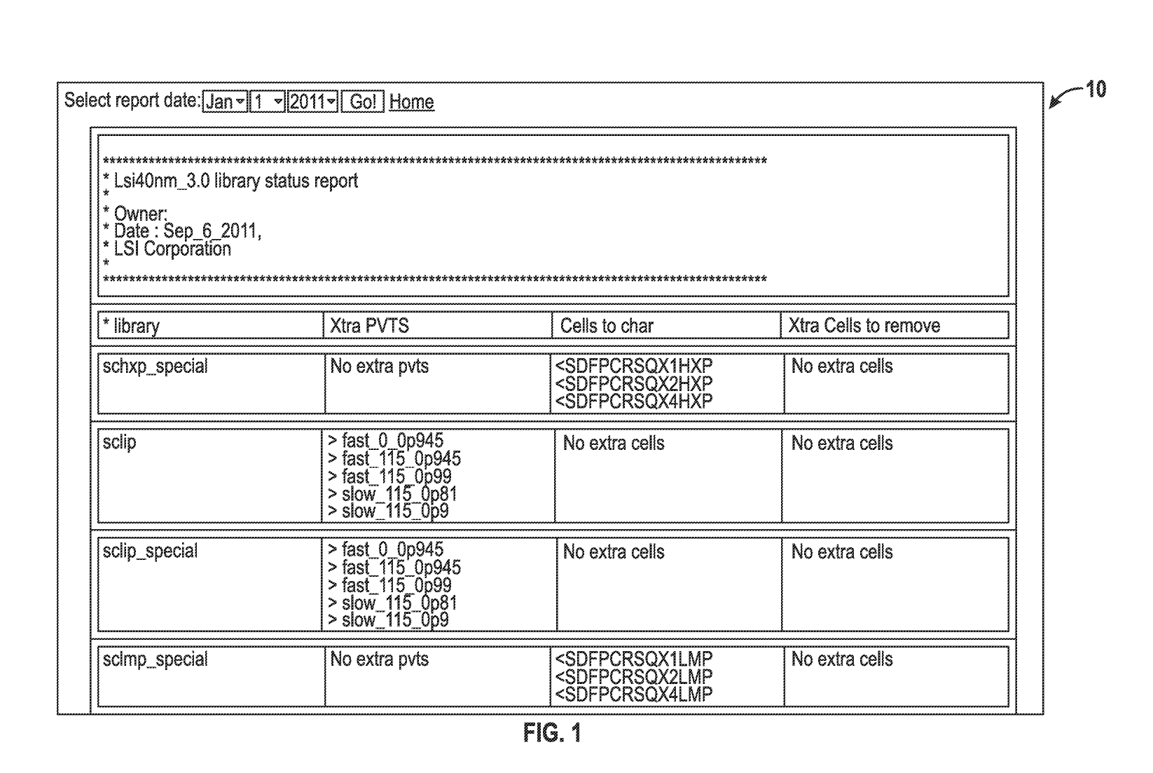

FIG. 1 illustrates a pictorial view of a noise assignment report 10, in accordance with an embodiment. Note that the term “cron” utilized herein refers generally to a time-based job scheduler in Unix-like computer operating systems that enables users to schedule jobs (e.g., commands or shell scripts) to run periodically at certain times or dates. A cron can be used to automate system maintenance or administration, though its general-purpose nature means that it can be used for other purposes such as connected to the Internet and downloading e-mail. A “cron” job can thus be run on a daily basis in order to parses the library check-in area for all the libraries, cells, and the liberty models. This data can be compared against the noise model repository. The difference in the database fetches the new libraries/cells/PVTs to be characterized.

Noise characterization requires spice netlist to be available for simulations. The auto tracking system checks the availability of spice netlists for all the new libraries before listing them for characterization. A detailed report containing libraries to be characterized, new cells added/removed, new PVTs added/removed is generated in html format and posted in the noise characterization website. This automation keeps track of phoenix assignments and customers commit dates. FIG. 1 thus illustrates the snapshot report 10 of tsmc_cln40g technology pin noise assignments in the context of a graphical user interface. The header of the report 10 contains details of the technology node along with the report generation date. Report 10 also lists the libraries, their corresponding PVTs, and cells to be characterized. Similar reports can be generated for each of the technology nodes and versions. The report 10 and data contained therein can be rendered via, for example, an internal noise characterization webpage

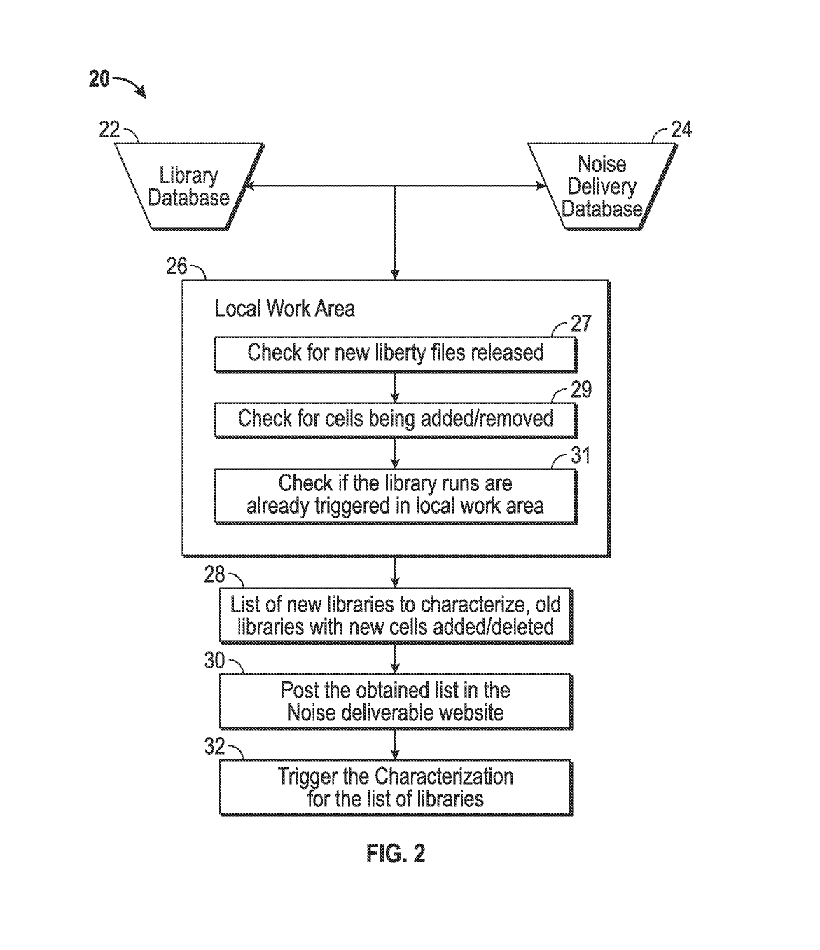

FIG. 2 illustrates a flow chart of operations depicting logical operation steps of an automated tracking and characterization method 20, in accordance with the disclosed embodiments. As indicated in FIG. 2, a library database 22 can communicate with a noise delivery database 24. A local work area 26 can also communicate with the library database 22 and the noise delivery database 24. The local work area 26 thus can retrieve data from databases 22 and 24. Blocks 27, 29, and 31 indicate a general flow or methodology for the local work area 26. As indicated at block 27, a step or logical operation can be implemented that checks for new liberty files released. Thereafter, as shown at block 29, a step or logical operation can be implemented for checking for cells being added/removed. Next, as described at block 31, a step or logical operation can be implemented for checking if the library runs are already triggered in the local work area 26.

Following processing of one or more of the operations depicted at blocks 27, 29, and 31, a list of new libraries to characterize can be generated and old libraries with new cells can be added or deleted, as depicted at block 28. Thereafter, as indicated at block 30, the obtained list in the noise deliverable website can be posted. Finally, as shown at block 32, characterizations can be triggered for the list of libraries.

Characterization runs are self-triggered once a pin noise assignment report such as report 10 shown in FIG. 1 is generated. A characterization engine checks a local run area to ensure the characterization runs are not initiated already for the given libraries as they could be triggered with the previous day's reports. Two noise characterization methodologies can be implemented. One approach involves a standard Hspice simulation based flow and the other flow involves an ultra high speed Forced Input Noise (FIN) flow.

The noise characterization processes typically require a great deal of man-hours and a tremendous amount of database follow-ups. With the automation in place, there is a big improvement in model turnaround time, lowered human intervention, and achieved high productivity. Successful generation of noise models can be confirmed with zero errors and warnings in the log files. The generated noise models can be automatically delivered into release area and phoenix assignments can be marked as delivered. FIG. 2 thus illustrates a detailed flow of auto library tracking and self-characterization triggering systems.

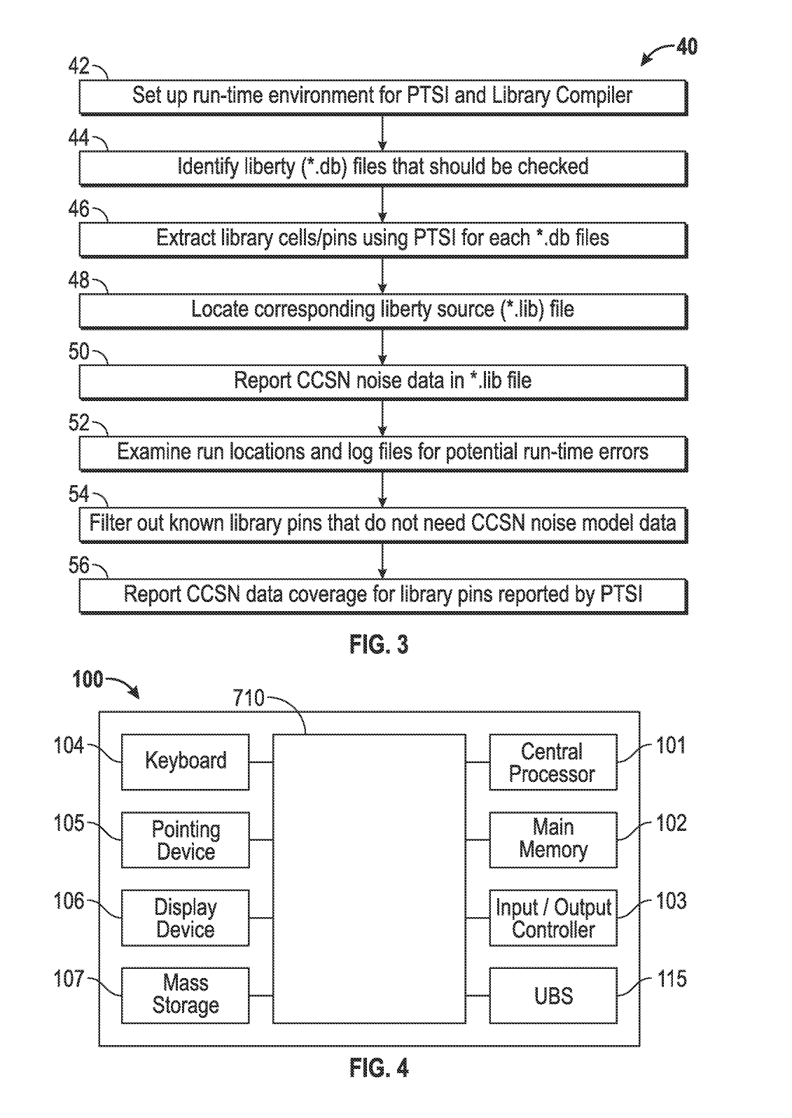

FIG. 3 illustrates a flow chart of operations depicting coverage analysis method 40, in accordance the disclosed embodiments. In general, quality and coverage checking is a vital process to ensure the models generated through automated flow are correct and complete. Core library cells must have CCSN noise models for PT SI noise sign off analysis to avoid chip integrity issues. The FIN flow for SNM generation is also dependent on CCSN data availability for all the libraries. A Library Compiler (LC) tool can be employed to examine the CCSN liberty models to ensure the CCS Noise curves are covered for all the cells. The flow chart of method 40 shown in FIG. 3 thus depicts the CCSN coverage analysis flow.

As indicated at block 42, a step or logical operation can be implemented for setting up a run-time environment for PTSI and the LC or LC tool discussed above. Next, as shown at block 44, a step or logical operation can be implemented for identify liberty (*.db) files that should be checked, Thereafter, as illustrated at block 46, a step or logical operation can be implemented for extracting cells pins using PTSI for each .db file. Then, as indicated at block 48, a step or logical operation can be implemented for locating a corresponding liberty source (*.lib) file. Next, as shown at block 50, a step or logical operation can be implemented for reporting CCSN noise data in a *.lib file, Thereafter, as described at block 52, a step or logical operation can be implemented for examining run locations and log files for potential run-time errors, Following processing of the operation depicted at block 52, a step or logical operation can be implemented for filtering out known library pins that do not need CCSN noise model data. Finally, as illustrated at block 56, a step or logical operation can be implemented for reporting CCSN data coverage for library pins reported by, for example, PTSI.

A CCSN coverage report for each of the library for a technology node can be tabulated, for example, in html format. In addition to CCSN checking, the SNM data is also checked for coverage. Every cell/pin in the library having SNM data ensures 100% noise coverage. The physical only cells such as Antenna cell, Fillers, etc., would miss the SNM data as they don't have any timing arcs, A detailed report of missing SNM data can be captured and tabulated in an Nail database.

The generated report is thus very useful in tracing out missing cells and characterization run failures, The missing cell report can be used to selectively run failed cell/pin simulation, thus saving a huge manual effort of identifying failed simulations and re-triggering characterization runs. The report also contains a list of cell/pins missing CCSN data. Such a report can additionally provide a detailed list of liberty files used to perform the coverage analysis. The coverage analysis flow can be run once in a week to ensure that the noise models are up-to-date and in sync with all the upstream deliverables,

The approach described herein offers a number of advantages and features, For example, such an approach can be implemented in the context of an “intelligent” database management system, which assesses the workload and provides systematic execution plan. The system is independent of manual report notifications sent by upstream kit owners. Self triggered characterization runs and failure detect ability provides an edge over conventional characterization engines. Also, constant monitoring of delivered models can ensure data non-corruption at any point of time.

The disclosed embodiments solve the problem of existing processes that require a great deal of man-hours and tremendous amounts of database follow-ups. With the automation of the disclosed embodiments in place, a significant improvement in model turnaround time, lowered human intervention, and higher productivity can be achieved. Thus, an efficient database management system can be implemented, which helps to keep track of the entire library development cycle. Additionally, technology specific library assignment reports assessing the characterization load and work planning can be generated. Such an auto report generation flow assists in gaining additional lead-time for characterization flow as the assignments are completed as soon as the upstream kits are available in the release area. This is independent of report notifications sent by upstream kit owners.

The characterization configuration files and inputs required for characterization runs are generally auto accumulated along with the report generation phase. The characterization runs can be automatically triggered as the required setups are available; this eliminates the human need for monitoring new libraries and initiating characterization runs. Additionally, the characterization engine can check the local run area or local work area 26 to ensure that the characterization runs are not initiated already for the given libraries as they could be triggered with the previous day's reports. The flow/method described herein is robust enough to track the failed jobs and simulations and retrigger the same. The noise model quality and coverage checks can be automatically performed and reports published on an internal noise characterization webpage. This flow is capable of reporting corrupted deliverables in the release area. The disclosed embodiments can also report missing models in the case of, for example, where the models are accidentally deleted. This approach ensures consistency between the models at a local characterization run area to the model at the release area. This ensures most updated models are available for customers. With this automation system/approach in place, a high model quality can be achieved along with the best model turnaround time with least human errors. A single modeling engineer can handle complete noise characterization activity with a highly efficient database management by employing the approach described herein.

As will be appreciated by one skilled in the art, the disclosed embodiments can be implemented as a method, data-processing system, or computer program product. Accordingly, the embodiments may take the form of an entire hardware implementation, an entire software embodiment or an embodiment combining software and hardware aspects all generally referred to as a “circuit” or “module.” Furthermore, the disclosed approach may take the form of a computer program product on a computer-usable storage medium having computer-usable program code embodied in the medium. Any suitable computer readable medium may be utilized including hard disks, USB flash drives, DVDs, CD-ROMs, optical storage devices, magnetic storage devices, etc.

Computer program code for carrying out operations of the present invention may be written in an object oriented programming language (e.g., JAVA, C++, etc.). The computer program code, however, for carrying out operations of the present invention may also be written in conventional procedural programming languages such as the “C” programming language or in a visually oriented programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, WiMax, 802.11x, and cellular network or the connection can be made to an external computer via most third party supported networks (e.g. through the Internet via an internet service provider).

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data-processing apparatus to produce a machine such that the instructions, which execute via the processor of the computer or other programmable data-processing apparatus, create means for implementing the functions/acts specified in the block or blocks discussed herein such as, for example, the various instructions shown with respect to particular blocks in FIGS. 2, 3.

These computer program instructions may also be stored in a computer-readable memory that can direct a computer or other programmable data-processing apparatus to function in a particular manner such that the instructions stored in the computer-readable memory produce an article of manufacture including instruction means which implement the function/act specified in the block or blocks.

The computer program instructions may also be loaded onto a computer or other programmable data-processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

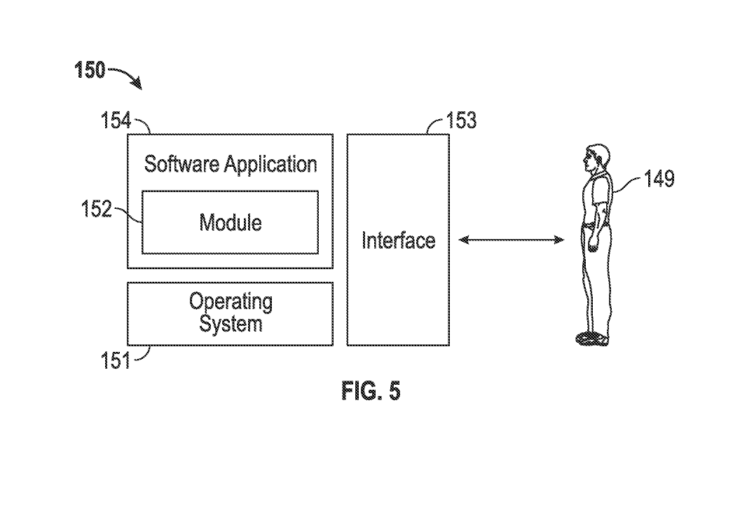

FIGS. 4-5 are provided as exemplary diagrams of data-processing environments in which embodiments of the present invention may be implemented. It should be appreciated that FIGS. 4-5 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 4, the disclosed embodiments may be implemented in the context of a data-processing system 100 that includes, for example, a central processor 101 (or other processors), a main memory 102, an input/output controller 103, and in some embodiments, a USB (Universal Serial Bus) 115 or other appropriate peripheral connection. System 100 can also include a keyboard 104, an input device 105 (e.g., a pointing device such as a mouse, track ball, pen device, etc.), a display device 106, and a mass storage 107 (e.g., a hard disk). As illustrated, the various components of data-processing system 100 can communicate electronically through a system bus 710 or similar architecture. The system bus 710 may be, for example, a subsystem that transfers data between, for example, computer components within data-processing system 100 or to and from other data-processing devices, components, computers, etc.

FIG. 5 illustrates a computer software system 150, which may be employed for directing the operation of the data-processing system 100 depicted in FIG. 4. Software application 154, stored in main memory 102 and on mass storage 107 shown in FIG. 5, generally includes and/or is associated with a kernel or operating system 151 and a shell or interface 153. One or more application programs, such as module(s) 152, may be “loaded” (i.e., transferred from mass storage 107 into the main memory 102) for execution by the data-processing system 100. The data-processing system 100 can receive user commands and data through user interface 153 accessible by a user 149. These inputs may then be acted upon by the data-processing system 100 in accordance with instructions from operating system 151 and/or software application 154 and any software module(s) 152 thereof.

The following discussion is intended to provide a brief, general description of suitable computing environments in which the system and method may be implemented. Although not required, the disclosed embodiments will be described in the general context of computer-executable instructions such as program modules being executed by a single computer. In most instances, a “module” constitutes a software application.

Generally, program modules (e.g., module 152) can include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked personal computers, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

The interface 153 (e.g., a graphical user interface) can serve to display results, whereupon a user may supply additional inputs or terminate a particular session. In some embodiments, operating system 151 and interface 153 can be implemented in the context of a “windows” system. It can be appreciated, of course, that other types of systems are possible, For example, rather than a traditional “windows” system, other operation systems such as, for example, a real time operating system (RTOS) more commonly employed in wireless systems may also be employed with respect to operating system 151 and interface 153. The software application 154 can include, for example, module.(s) 152, which can include instructions for carrying out steps or logical operations such as those shown in FIGS. 2-3 herein.

FIGS. 4-5 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, Unix, Linux, and the like.

Based on the foregoing, it can be appreciated that a number of embodiments, preferred and alternative., are disclosed herein. For example, in one embodiment, a method can be implemented for automatic self-tracking of input deliverables for noise characterization. Such a method can include, for example, the steps of logical operations of automatically initiating a noise characterization run to generate a noise model thereof, delivering the noise model into a repository in response to completing the noise characterization run and generating the noise model, and tracking data associated with the noise model for subsequent analysis including checking a completeness and a correctness of the noise model delivered into the repository.

In another embodiment, a step or logical operation can be implemented for rendering the data associated with the noise model for the subsequent analysis. In other embodiments, the data associated with the noise model can include, for example, data indicative of pending tasks, assignment information, a noise database, and so on. In another embodiment, the step or logical operation of rendering the data associated with the noise model for the subsequent analysis can further include the step or logical operation of publishing the data via an internal noise characterization webpage. In yet another embodiment, the step or logical operation of automatically initiating the noise characterization run to generate the aforementioned noise model can further include the step or logical operation of automatically initiating the noise characterization run as required library set-ups are needed.

In another embodiment, a system for automatic self-tracking of input deliverables for noise characterization can be implemented. Such a system can include, for example, a noise model automatically generated from a noise characterization run; and a repository in which the noise model is delivered in response to completing the noise characterization run and generating the noise model, wherein data associated with the noise model is automatically tracked for subsequent analysis including a check of a completeness and a correctness of the noise model delivered into the repository. Additionally, data associated with the noise model can include data indicative of, for example, pending tasks, assignment information, a noise database, etc. Additionally, in an alternative system embodiment, the data associated with the noise model can be published via an internal noise characterization webpage. In yet another embodiment, the noise characterization run can be automatically initialized as required library set-ups are needed.

In still another embodiment, a processor-readable medium storing code representing instructions to cause a process to automatically self-track input deliverables for noise characterization can be implemneted. Such code can include, for example, code to automatically initiate a noise characterization run to generate a noise model thereof, deliver the noise model into a repository in response to completing the noise characterization run and generating the noise model, and track data associated with the noise model for subsequent analysis including checking a completeness and a correctness of the noise model delivered into the repository.

In another embodiment, such code can further comprise code to render the data associated with the noise model for the subsequent analysis. As indicated previously, data associated with the noise model can include, for example, data indicative of pending tasks, assignment information, a noise database, and so on. In other embodiments, such code can further include code to publish the data via an internal noise characterization webpage. In still other embodiments, such code can further include code to automatically initiate the noise characterization run to generate the noise model thereof, further comprises code to automatically initiate the noise characterization run as required library set-ups are needed.

In still another embodiment, a system for automatic self-tracking of input deliverables for noise characterization can be provided. Such a system can include, for example, a processor, a data bus coupled to the processor: and a computer-usable medium embodying computer code, the computer-usable medium being coupled to the data bus. Such computer code can include, for example, instructions executable by the processor and configured for automatically initiating a noise characterization run to generate a noise model thereof, delivering the noise model into a repository in response to completing the noise characterization run and generating the noise model, and tracking data associated with the noise model for subsequent analysis including checking a completeness and a correctness of the noise model delivered into the repository.

In some embodiments, such instructions can be further configured for rendering the data associated with the noise model for the subsequent analysis. In yet other embodiments, such instructions can be further configured for publishing the data via an internal noise characterization webpage. In still other embodiments, such instructions can be further configured for automatically initiating the noise characterization run as required library set-ups are needed.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for automatic self-tracking of input deliverables for noise characterization, said method comprising:
automatically initiating a noise characterization run to generate a noise model;
delivering said noise model into an archival repository, comprising a noise delivery database in response to completing said noise characterization run and generating said noise model; and
tracking data associated with said noise model by a computer for subsequent analysis including checking a completeness and a correctness of said noise model delivered into said repository.

2. The method of claim 1 further comprising rendering said data associated with said noise model for said subsequent analysis.

3. The method of claim 1 wherein said data associated with said noise model includes pending tasks associated with said noise model.

4. The method of claim 1 wherein said data associated with said noise model includes user scheduling and assignment information.

5. The method of claim 1 wherein said data associated with said noise model includes a noise database.

6. The method of claim 2 wherein rendering said data associated with said noise model for said subsequent analysis further comprises publishing said data via an internal noise characterization webpage.

7. The method of claim 1 wherein automatically initiating a noise characterization run to generate a noise model thereof, further comprises:
automatically initiating said noise characterization run as required library set-ups are needed.

8. A system for automatic self-tracking of input deliverables for noise characterization, said system comprising:
a noise model automatically generated from a noise characterization run; and
an archival repository, comprising a noise delivery database in which said noise model is delivered in response to completing said noise characterization run and generating said noise model, wherein data associated with said noise model is automatically tracked for subsequent analysis including a check of a completeness and a correctness of said noise model delivered into said repository.

9. The system of claim 8 wherein said data associated with said noise model further comprises pending tasks associated with said noise model.

10. The system of claim 8 wherein said data associated with said noise model further comprises user scheduling and assignment information.

11. The system of claim 8 wherein said data associated with said noise model further comprises a noise database.

12. The system of claim 8 wherein said data associated with said noise model is published via an internal noise characterization webpage.

13. The system of claim 8 wherein said noise characterization run is automatically initialized as required library set-ups are needed.

14. A non-transitory computer processor-readable storage medium storing code representing instructions executed by a computer to cause a process to automatically self-track input deliverables for noise characterization, said code comprising code to:
automatically initiate a noise characterization run to generate a noise model thereof;
deliver said noise model into an archival repository, comprising a noise delivery database in response to completing said noise characterization run and generating said noise model; and
track data associated with said noise model for subsequent analysis including checking a completeness and a correctness of said noise model delivered into said repository.

15. The non-transitory computer processor-readable storage medium of claim 14 wherein said code further comprises code to render said data associated with said noise model for said subsequent analysis.

16. The non-transitory computer processor-readable storage medium of claim 14 wherein said data associated with said noise model includes pending tasks associated with said noise model.

17. The non-transitory computer processor-readable storage medium of claim 14 wherein said data associated with said noise model includes user scheduling and assignment information.

18. The non-transitory computer processor-readable storage medium of claim 14 wherein said data associated with said noise model includes a noise database.

19. The non-transitory computer processor-readable storage medium of claim 14 wherein said code further comprises code to publish said data via an internal noise characterization webpage.

20. The non-transitory computer processor-readable storage medium of claim 14 wherein said code to automatically initiate said noise characterization run to generate said noise model thereof, further comprises code to automatically initiate said noise characterization run as required library set-ups are needed.
